(19) United States
(12) Patent Application Publication
(10) Pub. No.: US 2005/0209956 A1
(43) Pub. Date: Sep. 22, 2005

(54) Mortgage loan application method and apparatus

(76) Inventor: S. Richard Whitworth, Pebble Beach, CA (US)

Correspondence Address: MARCUS G THEODORE, PC, 466 SOUTH 500 EAST, SALT LAKE CITY, UT, 84102, US

(21) Appl. No.: 11/082,434

(22) Filed: Mar. 17, 2005

Related U.S. Application Data
(60) Provisional application No. 60/554,800, filed on Mar. 22, 2004.

(51) Int. Cl. G06F 17/60

(52) U.S. Cl. 705/38

(57) ABSTRACT

A computerized method and apparatus for simplifying the complicated mortgage loan application process via inputting loan application data on a series of electronic screens utilizing indicia indicating if the form is complete or incomplete via red, yellow, and green light signals before generating loan documents for submittal and approval or denial.

### RELATED APPLICATIONS

This application is a continuation-in-part patent application of the provisional patent application entitled “Mortgage Loan Application Method And Apparatus”, Ser. No. 60/554,800 filed Mar. 22, 2004.

### BACKGROUND OF THE INVENTION

1. Field

This invention pertains to electronic processing of mortgage loan applications. In particular it pertains to an improved method and apparatus for electronically processing mortgage loan applications.

2. State of the Art

A number of computer methods for processing mortgages are known. The invention disclosed below provides a computerized method and apparatus for simplifying the complicated mortgage loan application process via a series of electronic screens utilizing indicia indicating if the form is complete before submittal. The software may be downloaded for use on a personal computer to better protect one's privacy. It is particularly suited for borrowers who have not previously applied for loans.

### SUMMARY OF THE INVENTION

The invention comprises a method for computer processing mortgage loan applications. It comprises: inputting into a computer processor the requirements to qualify for a mortgage loan, inputting a computer software program to process input data to determine if a loan applicant qualifies for a mortgage loan, filling out a series of data input screens with a loan applicant's loan information, testing the completeness of the data input screens with indicia indicating if the loan information on the data screens is complete, and computer processing the input data to determine if a loan applicant qualifies for a mortgage loan.

The computer software is designed to simplify the complicated mortgage loan application process through a variety of means; the use of displaying a simplified reduced number of fields plus offering the use of tool-tips for each required data field, while at the same time compiling a reminders list for additional documentation requirements based on the applicants data entries. If the data entries do not meet the background requirements for minimum data, additional dialog boxes will appear asking for the additional data required. The software is set in a series of folders enabling the borrower to see required ‘folder sections’ at one glance, while further enabling them to navigate between all of those folders and giving them an easy to recognize and understand indicia display light in the corner of each folder in RED, YELLOW, or GREEN. The sequence of lighting each folder is prompted by the status of data completed in each one. e.g., a folder section containing zero data, the light appears red, a folder with partial data is lighted yellow, and a fully executed folder (all fields containing required data) turns green. The final green occurs only when all data for any particular folder section is completed, including any additional dialog box information, which has been prompted in order to complete that folder's particular lending data requirements.

Once all of the folder lights are green the applicant can print a series of disclosure documents plus a reminder list of additional documents they must present based upon their data entries, entries, which relate to their particular circumstances. The reminder list prompts the completing the required fields and a series of internal validations and the verification of all lights being green. The final preparation folder also allows the applicant to submit the completed data in a variety of ways. A user can simply copy the data to a disk/CD, DVD, and present it in person, or they can link the data to the lender via encrypted email via the web, or it can be submitted through an underwriting/approval engine for full lender approval. All parties are notified via email of the status of the data.

The preferred software is both downloadable by the borrower for use in their own computer to insure confidentiality, and it is also web enabled and can be completed by the borrower on-line. According to a Fannie Mae survey, “a mere 2% will complete an online application. Conversely, Morgan Stanley reports that “maybe 10% will complete an online application by the year 2010. A preferred software known as Borroware® is produced by MorSystems of Carmel, Calif. provides this improved downloadable software for use on one's own computer.

### DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

FIG. 1 is a flow diagram of applicant's method.

FIGS. 2 through 7 are preferred software data input screens.

FIG. 8 illustrates a typical computer hardware network.

### DESCRIPTION OF THE ILLUSTRATED EMBODIMENTS

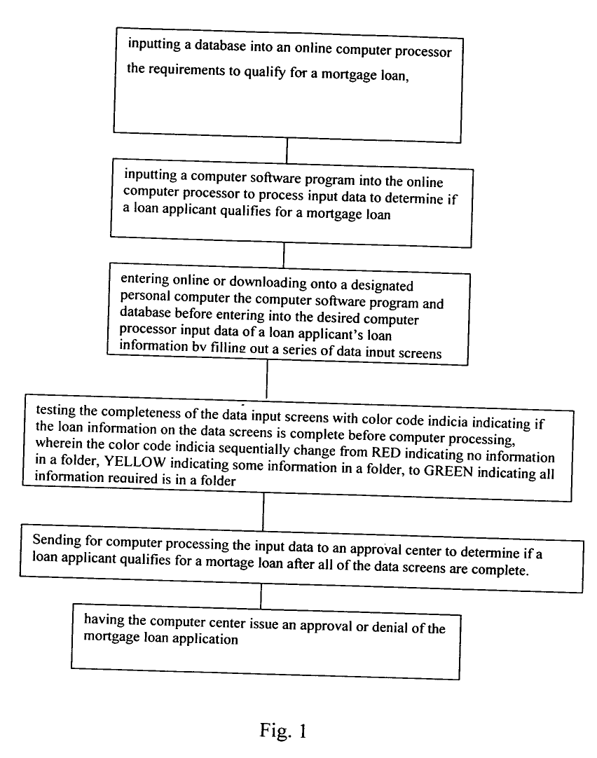

FIG. 1 is a flow diagram of applicant's method for computer processing mortgage loan applications. It comprises inputting a database into an online computer processor the requirements to qualify for a mortgage loan. Along with the database of requirement to qualify for a mortgage loan, a computer software program is also entered into the online computer processor to process input data to determine if a loan applicant qualifies for a mortgage loan. Next, the loan applicant's loan data is entered online or the computer software program is downloaded onto a designated personal computer before entering the loan applicant's loan information. This is accomplished by filling out a series of data input screens displayed on a computer terminal.

The completeness of the data input screens are checked with color code indicia indicating if the loan information on the data screens is complete before computer processing. The color code indicia sequentially change from RED indicating no information in a folder, YELLOW indicating some information in a folder, to GREEN indicating all information required is in a folder.

The completed folder information is then sent for computer processing the applicant's input data to an approval center to determine if a loan applicant qualifies for a mortgage loan after all of the data screens are complete. Lastly, the computer center issue an approval or denial of the mortgage loan application.

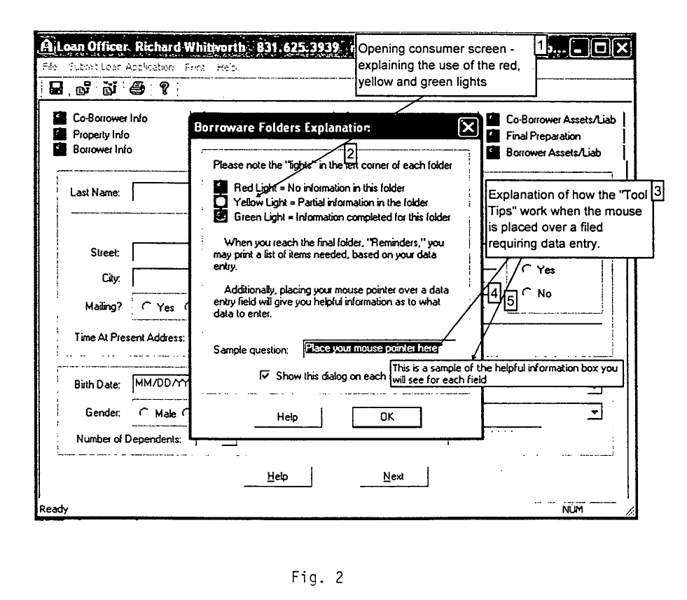

FIG. 2 is an opening consumer screen explaining the use of the red, yellow and green lights to indicate if the data is complete before the data information is entered on the various screens. It also explains how the Tool Tips function works when the mouse is placed over a field requiring data entry.

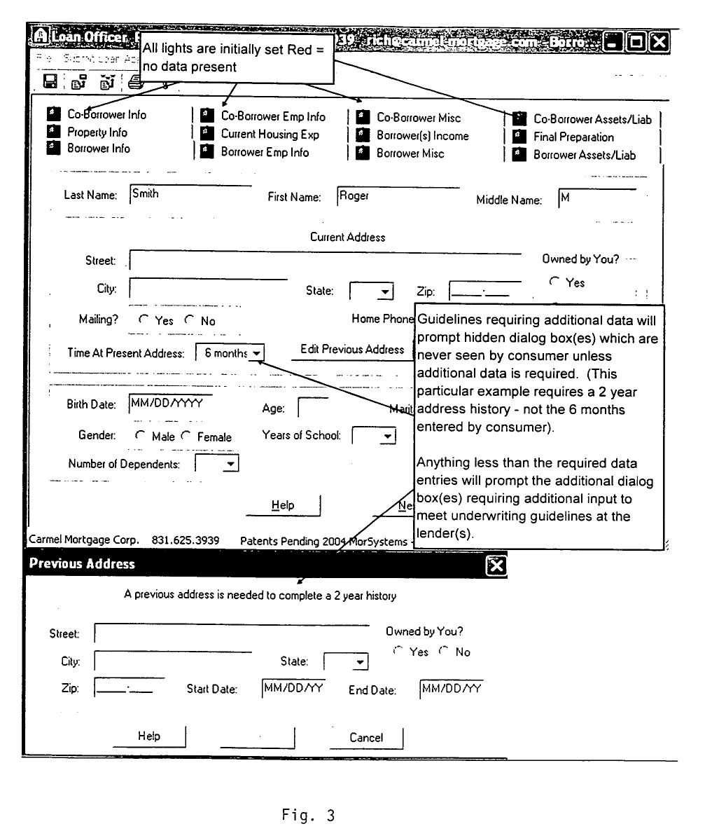

FIG. 3 indicates how all files are initially set to red indicating that no data is present in the files. FIG. 3 also shows how a dialogue box comes up to prompt what additional information is required to complete the data requested on the data input screen.

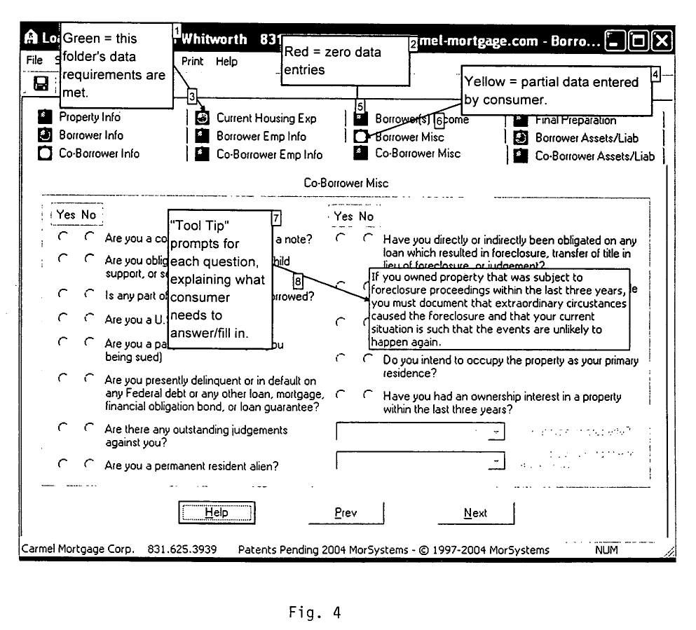

FIG. 4 shows how the color code indicial indicate the status of the data in each respective loan application file.

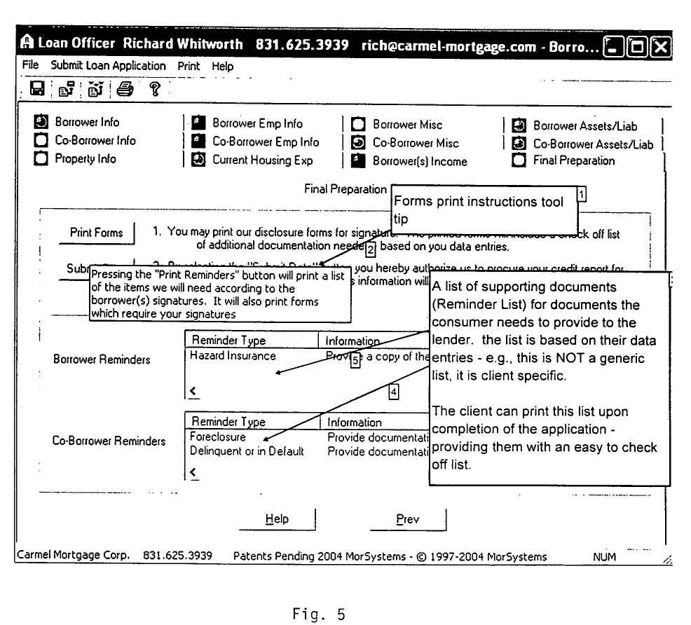

FIG. 5 illustrates how a list of supporting documents required to accompany the completed forms is identified and listed for processing the loan.

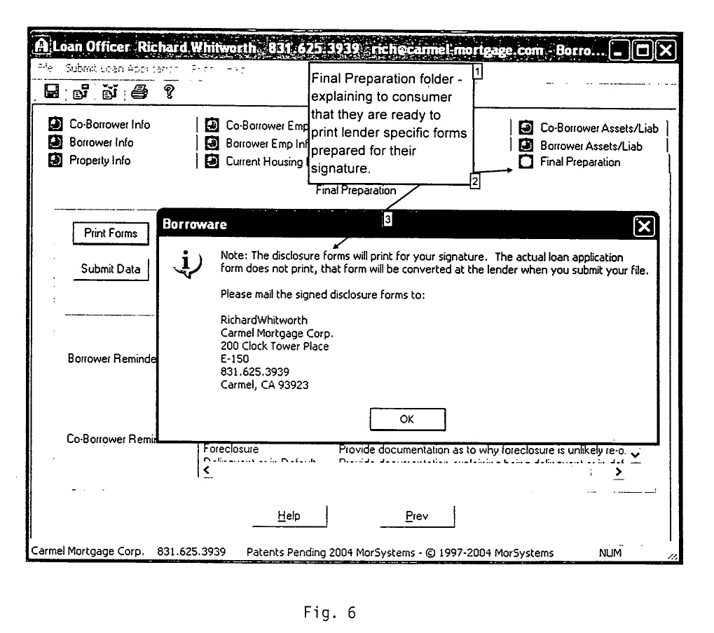

FIG. 6 is an example of the final preparation folder explaining to the loan customer that they are ready to print the lender specific forms for their signature and submittal along with the supporting documents.

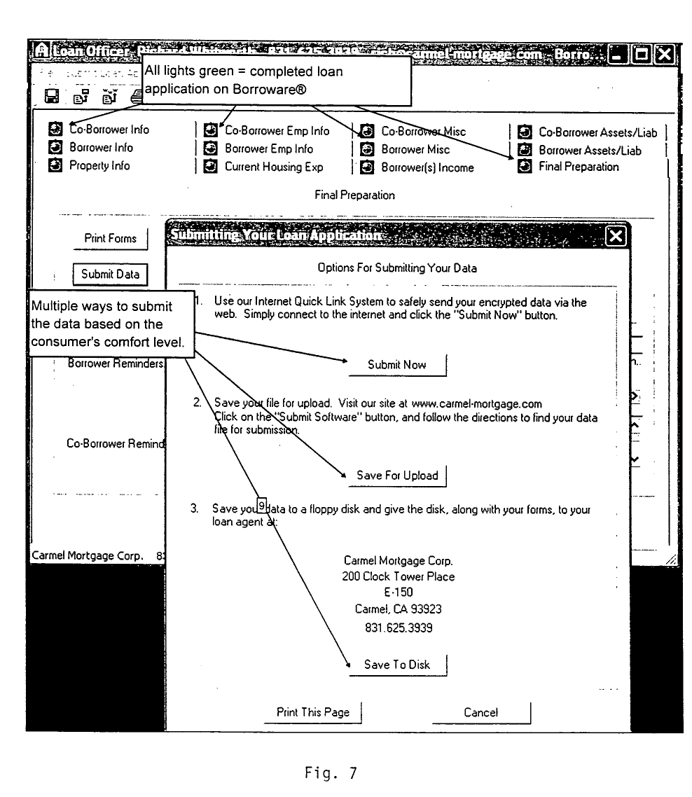

FIG. 7 is an instructional screen outlining the multiple ways in which the data may be submitted for processing.

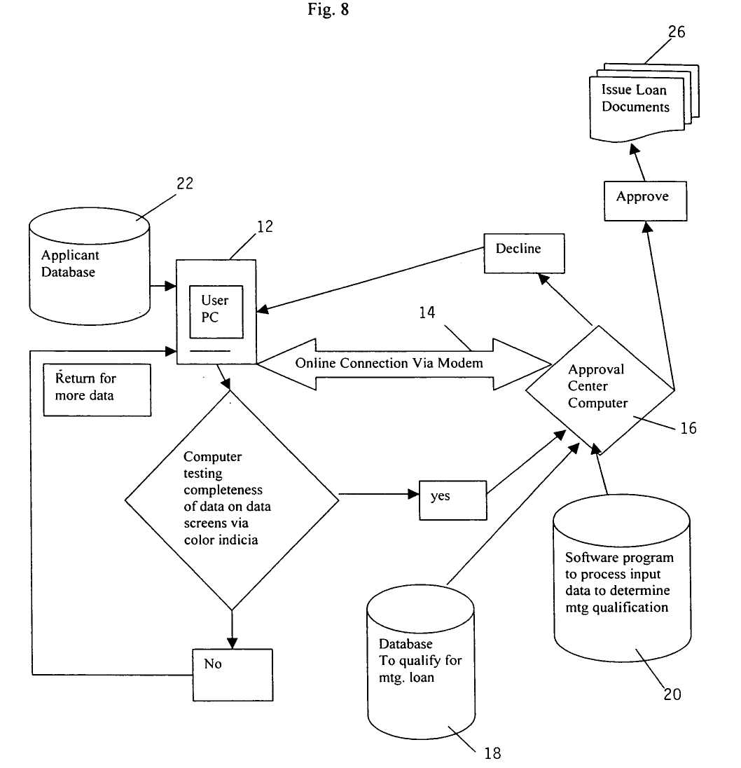

FIG. 8 illustrates a typical computer hardware network 10 employing applicant's invention for computer processing mortgage loan applications. It comprises a personal computer 12 in online communication via a modem 14 with a centralized computer processor 16. A database 18 is inputted into the centralized computer processor 16 containing the requirements to qualify for a mortgage loan. A computer software program 20 is inputted into the centralized computer 16, which may be downloaded onto the user designated personal computer 12 to process applicant input data 22 to determine if a loan applicant qualifies for a mortgage loan. An applicant's loan information input data 22 is inputted into the personal computer 12 by the applicant filling out a series of data input screens displayed on its computer terminal. These data input screens are similar to those described above and are programmed to test the completeness of the data input via color code indicia indicating if the loan information on the data screens is complete before computer processing. If the information is not complete, the user is computer notified to revise the data.

If it is complete, the data is forwarded to the centralized computer processor 16 for review. If the loan is approved, an output device 24 associated with the centralized computer processor 16 issues an approval and outputs the mortgage loan documents. If the loan is denied, the applicant is notified via the online connection 14 sending a declination message to the designated personal computer 12.

The invention provides a computerized method and apparatus for simplifying the complicated mortgage loan application process via a series of electronic screens utilizing color indicia indicating if the form is complete before submittal.

Although the specification refers to the illustrated embodiments, it is not intended to restrict the scope of the claims. The claims themselves recite those features deemed essential to the invention.

1. A method for computer processing mortgage loan applications, comprising:
a. inputting a database into an online computer processor the requirements to qualify for a mortgage loan,
b. inputting a computer software program into the online computer processor to process input data to determine if a loan applicant qualifies for a mortgage loan,
c. entering online or downloading onto a designated personal computer the computer software program and database before entering into the desired computer processor input data of a loan applicant's loan information by filling out a series of data input screens displayed on a computer terminal,
d. testing the completeness of the data input screens with color code indicia indicating if the loan information on the data screens is complete before computer processing,
e. sending for computer processing the input data to an approval center to determine if a loan applicant qualifies for a mortgage loan after all of the data screens are complete, and
f. having the computer center issue an approval or denial of the mortgage loan application.

2. A method for computer processing mortgage loan applications according to claim 1, wherein the color code indicia sequentially change from RED indicating no information in a folder, YELLOW indicating some information in a folder, to GREEN indicating all information required is in a folder.

3. A method for computer processing mortgage loan applications according to claim 2, wherein the color code indicia comprises a display light in the corner of each folder so that a RED signal indicates no data field entries on the data input screens, a YELLOW signal indicates incomplete data field entries on the data input screens, and a GREEN signal indicates completed data field entries on the data input screens.

4. A method for computer processing mortgage loan applications according to claim 3, wherein the final GREEN signal occurs only when all data for any particular folder section is completed, including any additional dialog box information, which has been prompted in order to complete that folder's particular lending data requirements.

5. A method for computer processing mortgage loan applications according to claim 4, wherein the computer software program uses simplified reduced number of field displays.

6. A method for computer processing mortgage loan applications according to claim 5, wherein the computer software includes offering the use of tool-tips for each required data field.

7. A method for computer processing mortgage loan applications according to claim 6, wherein the computer software at the time of data entry compiles a reminder list for additional documentation required based on the applicants data entries.

8. A method for computer processing mortgage loan applications according to claim 7, wherein if the data entries do not meet the background requirements for minimum data, the computer software includes additional dialog boxes which appear asking for additional data required.

9. A method for computer processing mortgage loan applications according to claim 8, wherein the computer software is set in a series of folder displays on the computer terminal enabling the borrower user to see required ‘folder sections’ at one glance.

10. A method for computer processing mortgage loan applications according to claim 9, wherein the computer terminal displays further enabling the user to navigate between the folder displays.

11. A method for computer processing mortgage loan applications according to claim 10, including computer printing a series of disclosure documents based upon the input data entries once all the folder lights are green.

12. A method for computer processing mortgage loan applications according to claim 11, including printing a reminder list of additional documents the loan applicant must present based upon their data entries to qualify for a mortgage loan.

13. A method for computer processing mortgage loan applications according to claim 12, including submitting the data entries for qualifying for a mortgage loan, issuing a loan approval, and notifying all parties of the status of the loan approval.

14. A method for computer processing mortgage loan applications according to claim 13, wherein the data entries are submitted through an underwriting/approval engine for full lender approval.

15. An apparatus for computer processing mortgage loan applications, comprising:
a. a designated computer in communication with or an computer processor,
b. a database inputted into the computer processor of the requirements to qualify for a mortgage loan,
c. a computer software program inputted into the online or downloaded into a designated personal computer processor to process input data to determine if a loan applicant qualifies for a mortgage loan,
d. a computer terminal associated with the computer processor for inputting into the online or designated computer processor data of a loan applicant's loan information by filling out a series of data input screens displayed on the computer terminal, said data screens programmed to test the completeness of the data input screens with color code indicia indicating if the loan information on the data screens is complete before computer processing,
e. an output device associated with the computer terminal for issuing an approval or denial of a mortgage loan application after the computer processes the input data to determine if a loan applicant qualifies for a mortgage loan after all of the data screens are complete.

16. An apparatus for computer processing mortgage loan applications according to claim 16, wherein the color code indicia sequentially change from RED indicating no information in a folder, YELLOW indicating some information in a folder, to GREEN indicating all information required is in a folder.

17. An apparatus for computer processing mortgage loan applications according to claim 16, wherein the color code indicia comprises a display light in the corner of each folder so that a RED signal indicates no data field entries on the data input screens, a YELLOW signal indicates incomplete data field entries on the data input screens, and a GREEN signal indicates completed data field entries on the data input screens.

18. An apparatus for computer processing mortgage loan applications according to claim 17, wherein the final GREEN signal occurs only when all data for any particular folder section is completed, including any additional dialog box information, which has been prompted in order to complete that folder's particular lending data requirements.

19. An apparatus for computer processing mortgage loan applications according to claim 18, wherein the computer software program uses simplified reduced number of field displays.

20. An apparatus for computer processing mortgage loan applications according to claim 19, wherein the computer software includes offering the use of tool-tips for each required data field.

21. An apparatus for computer processing mortgage loan applications according to claim 20, wherein the computer software at the time of data entry compiles a reminder list for additional documentation required based on the applicants data entries.

22. An apparatus for computer processing mortgage loan applications according to claim 21, wherein if the data entries do not meet the background requirements for minimum data, the computer software includes additional dialog boxes which appear asking for additional data required.

23. An apparatus for computer processing mortgage loan applications according to claim 22, wherein the computer software is set in a series of folder displays on the computer terminal enabling the borrower user to see required ‘folder sections’ at one glance.

24. An apparatus for computer processing mortgage loan applications according to claim 23, wherein the computer terminal displays further enabling the user to navigate between the folder displays.

25. An apparatus for computer processing mortgage loan applications according to claim 24, including a computer printer printing a series of disclosure documents based upon the input data entries once all the folder lights are green.

26. An apparatus for computer processing mortgage loan applications according to claim 25, wherein the computer processor prints a reminder list of additional documents the loan applicant must present based upon their data entries to qualify for a mortgage loan.

27. An apparatus for computer processing mortgage loan applications according to claim 26, including a data base of data entries for qualifying for a mortgage loan, and wherein the computer processor printer issues a loan approval, and notifies all parties of the status of the loan approval.

28. An apparatus for computer processing mortgage loan applications according to claim 27, including an underwriting/approval engine to submit the data entries for full lender approval.
